(19) United States
(12) Patent Application Publication
(10) Pub. No.: US 2011/0055537 A1
(43) Pub. Date: Mar. 3, 2011

(54) ELECTRONIC DEVICE AND BOOTING METHOD THEREFOR

(75) Inventor: PENG-ZHENG YANG, Tu-Cheng (TW)

(73) Assignee: HON HAI PRECISION INDUSTRY CO., LTD., Tu-Cheng (TW)

(21) Appl. No.: 12/611,146

(22) Filed: Nov. 3, 2009

(30) Foreign Application Priority Data
Aug. 31, 2009 (CN) 200910306380.0

(51) Int. Cl. G06F 9/24

(52) U.S. Cl. 713/2

(57) ABSTRACT

An electronic device of multiple operating systems includes a mode selecting module, an operating system selecting module, and a boot loader module. The mode selecting module is capable of selecting a desired booting mode. The operating system selecting module is capable of selecting one of the operating systems according to the selected booting mode. The boot loader module is capable of loading the selected operating system. A booting method for the electronic device is also disclosed.

### BACKGROUND

1. Technical Field

The present disclosure relates to an electronic device having multiple operating systems (OSs) and a booting method for the electronic device.

2. Description of Related Art

Nowadays, a user of an electronic device (such as a computer) is free to purchase and install an operating system that differs from the one installed on the device when it was purchased. There are numerous commercially available operating systems to choose from including, but not limited, to MS-DOS, UNIX, LINUX, OS/2, WINDOWS 3.x, WINDOWS NT, and WINDOWS 95.

Although these operating systems perform similar tasks, and many are capable of running the same application programs, each operating system has its own strengths. Sometimes a user wishing to capitalize on the strengths of these operating systems will install more than one OS on the same computer. Commercially available software utilities aid a user in installing additional operating systems on their computers. These utilities also allow a user to choose which operating system to boot while a computer is being powered-on or reset. The capability to boot different operating systems on the same computer is often referred to as an OS multi boot or multi booting. Despite the fact that many attempts have been made in the art, this kind of technology still has much room for improvement.

### BRIEF DESCRIPTION OF THE DRAWINGS

FIG. 1 a schematic block diagram of an electronic device in accordance with one embodiment.

FIG. 2 is a flow chart of a booting method for an electronic device in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

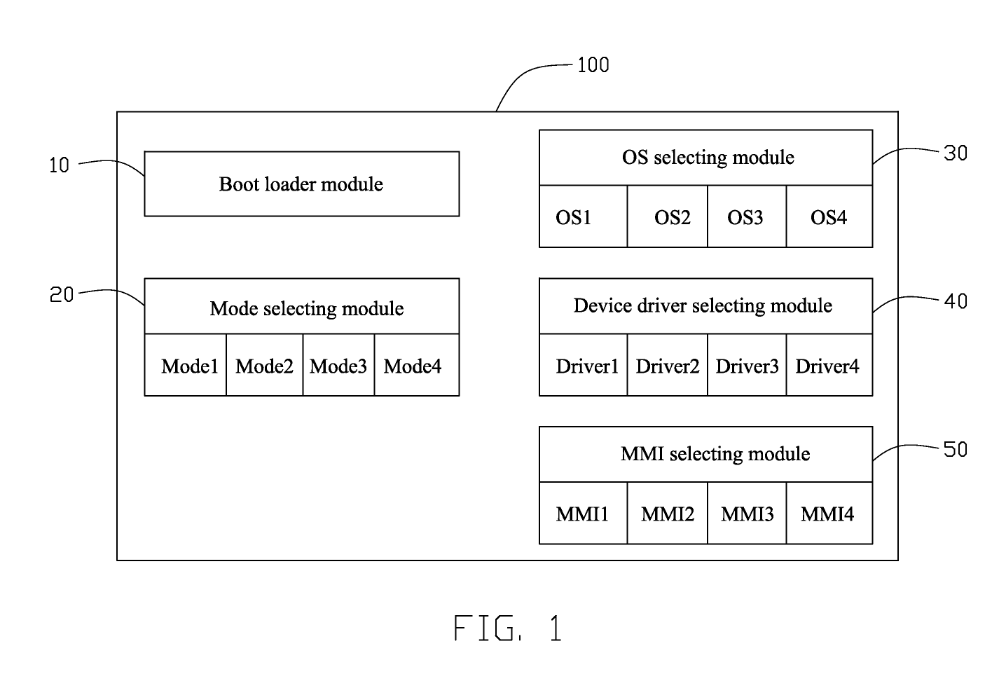

Referring to FIG. 1, an electronic device 100 in accordance with one embodiment includes a boot loader module 10, a mode selecting module 20, an operating system (OS) selecting module 30, a device driver selecting module 40, and a man-machine interface (MMI) selecting module 50. The electronic device 100 stores programs and data of different OSs (e.g., WINDOWS 2000, WINDOWS XP, WINDOWS VISTA, LINUX, etc), different device drivers (e.g., WINDOWS device drivers, LINUX device drivers, etc), and different MMIS (e.g., WINDOWS MMIS, LINUX MMI, etc). The device drivers and the MMIS are respectively compatible and matched with the corresponding operating systems.

A memory space of the electronic device 100 can be divided into several areas. Each of the areas is configured to store the programs and data of the OS, the device driver, and the MMI of a same type. For instance, programs of WINDOWS XP OS, WINDOWS XP device drivers, and WINDOWS XP MMI are stored in one of the areas; programs of LINUX OS, LINUX device driver, and LINUX MMI are stored in another one of the areas.

The boot loader module 10 includes a small program that can load the operating system programs and data which are then executed from Random Access Memory (RAM).

The mode selecting module 20 is capable of selecting Mode1, Mode2, Mode3, or Mode4. Mode1 is a manufacture booting mode applicable during manufacturing the electronic device 100. Mode2 is a normal booting mode applicable to a common user of the electronic device 100. Mode3 is a rescue booting mode applicable during repairing the electronic device 100. Mode4 is a recover booting mode applicable during restoring the electronic device 100 to factory settings. Mode2 is set as the default booting mode. If the electronic device 100 does not receive any command to interrupt its booting process, the default booting mode is automatically selected. If the electronic device 100 receives a specified command during the booting process, another booting mode other than the default booting mode can be selected according to the user's selection.

The OS selecting module 30 is capable of selecting OS1 (e.g., WINDOWS 2000), OS2 (e.g., WINDOWS XP), OS3 (e.g., WINDOWS VISTA), or OS4 (e.g., LINUX). The OS1, OS2, OS3, and OS4 are respectively corresponding to the Mode1, Mode2, Mode3, and Mode4. For instance, if Mode1 is selected by the mode selecting module 20, the OS selecting module 30 will select OS1.

The device driver selecting module 40 is capable of selecting one kind of device driver (Driver1, Driver2, Driver3, or Driver4) matched with the selected operating system. For instance, if OS1 (e.g., WINDOWS 2000) is selected by the OS selecting module 30, the device driver selecting module 40 will select Driver1 (WINDOWS 2000 device drivers) correspondingly.

The MMI selecting module 50 is capable of selecting one kind of MMI (MMI1, MMI2, MMI3, or MMI4) matched with the selected operating system. For instance, if OS1 (e.g., WINDOWS XP operating system) is selected by the OS selecting module 30, the MMI selecting module 50 will correspondingly select MMI1 (WINDOWS XP MMI) to be implemented.

In one embodiment, the electronic device 100 can be a personal computer or other consumer electronic devices, such as a digital photo frame, a mobile phone, etc. If a common consumer uses the electronic device 100, the mode selecting module 20 can automatically select the normal booting mode applicable to the common user. During manufacturing the electronic device 100, a manipulator can input a command (e.g., pressing F8 to input a command) to select the manufacture booting mode. If the electronic device 100 is being repaired, the mode selecting module 20 can select the rescue booting mode according to user's selection. If the electronic device 100 needs to be restored to factory settings, the mode selecting module 20 can select the recover booting mode according to user's selection.

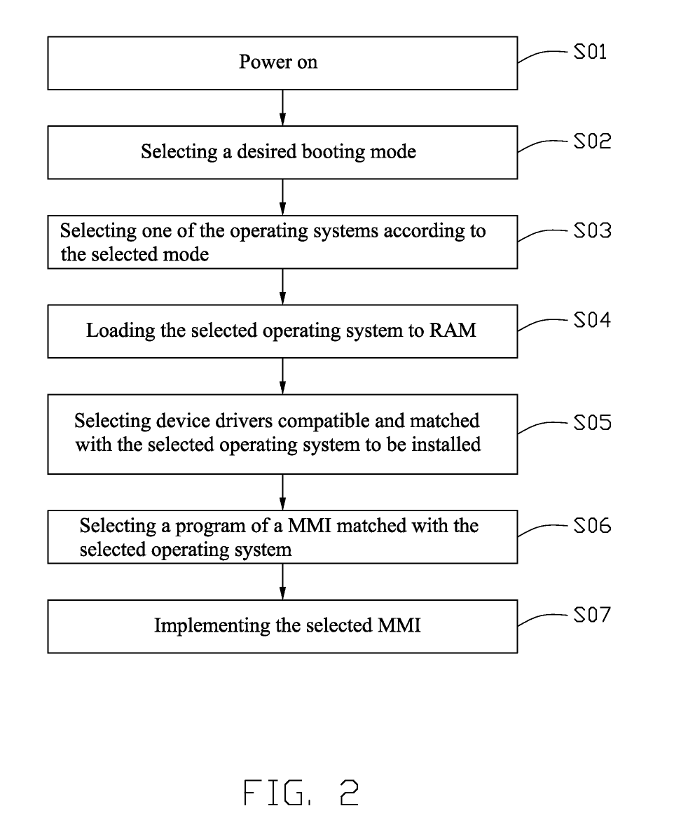

Referring to FIG. 2, one embodiment of a booting method for the electronic device 100 includes following blocks.

In block S01, a power button of the electronic device 100 is actuated to power on the electronic device 100.

In block S02, the mode selecting module 20 runs and selects a desired booting mode. If the mode selecting module 20 does not receive any input command during running, the mode selecting module 20 automatically selects the default booting mode (e.g. normal booting mode). If the mode selecting module 20 receives an input command during running, the mode selecting module 20 can select another booting mode (e.g. the manufacture booting mode, the rescue booting mode, or the recover booting mode) according to the input command.

In block S03, the OS selecting module 30 selects one of the operating systems (OS1, OS2, OS3, or OS4) according to the selected mode. For example, if the mode selecting module 20 selects Mode2 (normal booting mode), the OS selecting module 30 correspondingly selects OS2 (e.g., WINDOWS XP).

In block S04, the boot loader module 10 loads the selected OS to RAM.

In block S05, the device driver selecting module 40 selects one kind of device driver that is compatible and matched with the selected OS. Then the selected device driver is installed automatically.

In block S06, the MMI selecting module 50 selects a program of a MMI that is matched with the selected operating system.

In block S07, the selected MMI is implemented.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

It is also to be understood that the above description and the claims drawn to a method may include some indication in reference to certain steps. However, the indication used is only to be viewed for identification purposes and not as a suggestion as to an order for the steps.

What is claimed is:

1. An electronic device with a plurality of operating systems, the electronic device comprising:
a mode selecting module capable of selecting a desired booting mode;
an operating system selecting module capable of selecting one of the plurality operating systems according to the selected booting mode; and
a boot loader module capable of loading the selected operating system.

2. The electronic device of claim 1, further comprising a driver selecting module capable of selecting a device driver matched with the selected operating system.

3. The electronic device of claim 2, further comprising a man-machine interface selecting module capable of selecting a man-machine interface matched with the selected operating system.

4. The electronic device of claim 1, wherein a memory space of the electronic device is capable of being divided into several areas; and each of the areas is configured to store the programs and data of the operating system, the device driver, and the MMI of a same type.

5. The electronic device of claim 1, wherein the selected booting mode is a manufacture booting mode, a normal booting mode, a rescue booting mode, or a recover booting mode.

6. The electronic device of claim 1, wherein the electronic device is a computer system.

7. The electronic device of claim 1, wherein the electronic device is a digital photo frame.

8. A booting method for an electronic device having multiple operating systems, comprising:
selecting a desired booting mode;
choosing one of the multiple operating systems according to the desired booting mode; and
loading the selected operating system;
installing a device driver matched with the selected operating system; and
implementing a man-machine interface matched with the selected operating system.

9. The booting method of claim 8, wherein a default booting mode is automatically selected as the desired booting mode if there is not any input command to change the default booting mode.

10. The booting method of claim 9, wherein the default booting mode is a normal booting mode that is suitable for a common user of the electronic device.

11. The booting method of claim 8, wherein the desired booting mode is selected according to a specific input command.

12. The booting method of claim 11, wherein during manufacturing the electronic device, the selected booting mode is a manufacture booting mode; during repairing the electronic device, the selected booting mode is a rescue booting mode; and during restoring the electronic device to factory settings, the selected booting mode is a recover booting mode.

13. The booting method of claim 8, further comprising associating the device driver matched with the selected operating system before installing the device driver.

14. The booting method of claim 8, further comprising linking the man-machine interface matched with the selected operating system before implementing the man-machine interface.

15. A booting system for an electronic device having multiple operating systems, comprising:
a mode selecting module capable of selecting a desired booting mode;
an operating system selecting module capable of choosing one of the multiple operating systems according to the desired booting mode;
a boot loader module capable of loading the selected operating system;
a device driver selecting module capable of installing a device driver matched with the selected operating system; and
a man-machine interface selecting module capable of implementing a man-machine interface matched with the selected operating system.
